(19) United States
(12) Patent Application Publication
(10) Pub. No.: US 2026/0231861 A1
(43) Pub. Date: Aug. 13, 2026

(54) IMPLEMENT MONITORING

(71) Applicant: AGCO International GmbH, Neuhausen Am Rheinfall (CH)

(72) Inventors: Morten Stigaard LAURSEN, Randers (DK); Martin Peter CHRISTIANSEN, Randers (DK)

(21) Appl. No.: 19/471,258

(22) PCT Filed: Feb. 27, 2024
(86) PCT No.: PCT/IB2024/051850

§ 371 Date: Sep. 30, 2025

(30) Foreign Application Priority Data
Mar. 30, 2023 (GB) 2304757.4

(51) Int. Cl. A01D 41/127

(52) U.S. Cl. CPC A01D 41/127

(57) ABSTRACT

Methods and systems are provided for monitoring operation of an agricultural implement, such as a header for a harvesting machine. Sensor data from an event based sensor is used to identify one or more components of the implement and movement associated therewith. Operational parameters of the component(s) can be determined in dependence on the sensor data and be used to control operation of one or more operable components associated with the machine.

### CROSS-REFERENCE TO RELATED APPLICATIONS

Not applicable.

### FIELD

Embodiments of the present disclosure relate generally to systems and methods for monitoring operation of agricultural implements.

### BACKGROUND

Many agricultural processes involve the use of an implement operably coupled to a machine for engaging or otherwise processing material, such as crop material. Such processes typically require an operator to monitor the effectiveness of the operation and adjust components of the machine and/or implement accordingly.

For example, in a conventional harvesting process using a harvesting machine such as a combine harvester, an operator is required to manually adjust numerous parameters of the harvester in order to maintain an acceptable/desirable flow of material through the header and into the machine to ensure that all available crop material is harvested as efficiently and quickly as possible whilst at the same time preventing any blockages from occurring, e.g. through overworking of various components of the header and/or machine due to an excessively high flow rate of material through the components. This typically involves the operator adjusting the parameters to achieve a substantially uniform flow of material into and through the header, e.g. laterally across the header. Such parameters may include the height of the header, reel speed, reel height, reel position, belt speeds, cutter bar speeds and position, pitch angle of the header, etc. This can result in a high operator workload, leading to an increased likelihood of operator error and ultimately reduced efficiency and effectiveness of the harvesting process as a whole.

At the same time, an operator will observe components of the header to determine whether they are operating correctly. This increases operator workload further. Furthermore, fault components may only become apparent visually to the operator at a point where a major fault has occurred leading to downtime for the machine and again, reduced efficiency and effectiveness of the harvesting process.

It would therefore be advantageous to provide an improved system and method for monitoring operation of an agricultural implement, such as a harvesting header, which further assists an operator.

### BRIEF SUMMARY

In an aspect of the invention there is provided a system for monitoring operation of an implement for an agricultural machine, the system comprising: an event based sensor; and one or more controllers, configured to: receive sensor data from the event based sensor; analyse the sensor data to identify one or more components of the implement and movement associated therewith; determine or more operational parameters of the component(s) in dependence on the sensor data; and generate and output one or more control signals for controlling operation of one or more operable components associated with the agricultural machine in dependence on the determined operational parameter(s).

Advantageously, the present solution may provide means to monitor operational parameters associated with the operation of an agricultural implement, such as a header for a harvesting machine. As discussed herein, an event based sensor may advantageously provide a greater understanding of the motion of the components of the implement when compared with conventional, optical based imaging systems, and may be used in low light conditions for example, where RGB or other camera based systems may be unusable. Furthermore, event based sensors may provide information relating to variations in the movement of components of the implement which may otherwise be imperceptible to an operator viewing the implement directly or via a camera based system. This could be used to identify potential issues with said components prior to a major fault/component damage and a suitable alert or other notification be provided to the operator.

When used herein and throughout the term “event based sensor” is intended to include a sensor having multiple individual sensing elements or pixels which are individually triggerable in dependence on one or more variations in the signal output associated with those elements. The one or more variations may include a change in amplitude, brightness or measure of contrast associated with the sensing elements. Such a change may indicate movement in the observed environment, for example. Such sensor types may also be referred to as a neuromorphic camera, a silicon retina or dynamic vision sensor.

The one or more controllers may be configured to receive operational data from a controller network of the machine. The operational data may be indicative of an operational state of the machine, including an indication of the initiation of one or more operations. For example, in embodiments, the machine may comprise a tractor and the implement may comprise a baling machine, and here the operational data may be indicative of the start of a bale release process, for example. The operational data may be used by the one or more controllers and as a control signal for defining a monitoring period for the system. This may reduce processing requirements for the system by only analysis sensor data from the event based sensor during a relevant operation of the implement and/or machine-implement combination.

The one or more operational parameters may be used to determine a performance metric for the implement and its operation. For instance, the one or more operational parameters may be used to identify an operational issue associated with the implement, e.g. plugging of material, component breakage etc. This may be identified via a change in the operational parameter at the location of the blockage and/or at the location of faulty componentry of the implement, and/or a difference in operational parameter(s) across the implement and/or with respect to a baseline measurement—i.e. an expected operational parameter under given operating conditions.

The one or more operational parameters may include an operational speed for one or more components of the implement. The one or more operational parameters may include a measure of a variation in an operational characteristic observed from the sensor data. For instance, this can be obtained through comparison of the observed operational parameter e.g. an operational speed-with an expected operational parameter for a given operation or for given conditions. An expected parameter may be stored in a memory associated with the one or more controllers, or could comprise an average observed parameter. In this way, a comparison of the observed operational parameter(s) with a baseline measure may be used to infer an issue with the observed component.

The one or more operational parameters may include an operational frequency associated with the component(s). This may include a rotational frequency of one or more rotational components of the implement. The one or more controllers may be operable to analyse the sensor data to identify therein one or more cyclical paths corresponding to successive triggers of two or more adjacent sensing elements of the event based sensor. The one or more controllers may be configured to determine therefrom a time period for a complete circular path in the sensor data, that is, the time between successive triggers of sensing elements corresponding to the start and end of the circular path. The one or more controllers may be configured to compare the determined time period with an operational frequency of, for example, the power take off shaft (PTO) of the machine providing motive force to components of the implement. This information may be determined through receipt of signals from a controller network of the machine, such as the CAN. The one or more controllers may be operable to identify one or more anomalies in the component's operation in dependence on said comparison.

The one or more operational parameters may include a measure of a structural vibration of one or more components of the implement. The measure of vibration may include a measure of the frequency and/or amplitude of said vibration. The one or more controllers may be configured to compare the observed vibration measure with a threshold and infer an issue with the observed component(s) in dependence thereon. For instance, a high level of vibration (compared with a baseline acceptable level) may indicate a component fault, material blockage or the like. Advantageously, utilising an event based sensor may allow such vibrations to be determined sufficiently early to allow action to be taken prior to a more significant issue occurs—e.g. full component fault, plugging of the implement, etc.—which may cause further downtime and additional cost to the operator.

4

The one or more controllers may be configured to control application of a filter to output signals from the sensing elements. The filter may be applied to the output signals to remove triggers of individual sensing elements due to background motion. For example, this may be due to the relative movement of the ground causing changes in the light incident on the sensing elements as the machine performs a task, or due to structural vibration and/or component motion during said tasks. Advantageously, applying one or more filters to the analogue output signal from the sensing elements may control the number of individual triggers to be processed by the event based sensor and/or one or more processing units associated therewith.

Additionally or alternatively, the one or more controllers may be configured to apply a filter to the sensor data. Where the processing capabilities of the controllers is high enough it may be possible to receive all triggers and apply said filter(s) digitally to remove or discard unwanted triggers.

The filter may comprise a threshold for an output signal associated with the sensing elements, which may include amplitude or rate of change of amplitude of the output signal. The threshold may be definable and/or be dependent on the agricultural task (to be) performed by the agricultural machine.

The filter may be dependent on a ground speed of the agricultural machine. Advantageously, the relative movement of the ground with respect to the machine, and hence the sensor, may be excluded from the sensor data. The filter may be dependent on an operational speed of the implement, which may include a rotational speed or one or more rotational components of the implement, for example. In such instances, the sensor may be configured to trigger only when the operational parameters associated with the implement (or component(s) thereof) fall outside of an expected operating range.

The filter may comprise a mask applied to a sensing region of the sensor, e.g. to exclude regions of the sensing region which do not correspond to the implement and/or a material flow associated therewith.

The system may include one or more additional sensors. Data from the one or more additional sensors may be useable by the one or more controllers for positioning of the implement within the sensor data from the event based sensor, for example. The one or more additional sensors may comprise a camera, LIDAR unit, RADAR unit or the like.

The system may include one or more motion sensors, such as an accelerometer, gyroscope, inertial measurement unit (IMU) or the like. The one or more motion sensors may be provided for comparison with the event based sensor data to determine the operational parameter(s) associated therewith. For example, where the system is configured for monitoring a rotational frequency of one or more components of the implement, the motion sensor(s) may be placed on or otherwise associated with the rotational elements of the implement for providing a secondary measure of the rotational frequency thereof.

The implement may comprise an integral part of the agricultural machine. The implement may be a separable mountable component which may be operably coupled to the machine, as will be appreciated. For example, the implement may be operably coupled to a hitch point on the machine, and which may be carried or towed by the machine, in use.

The implement may comprise a header for a harvesting machine, such as a header for a combine harvester. The header may include one or more operable components, such as a reel, conveyor, cutter bar or the like, as will be appreciated.

The implement may comprise a grass turning implement. The one or more controllers may be configured to monitor an operational frequency of one or more components of the grass turning implement. For example, the one or more controllers may utilise the sensor data to determine a rotational frequency of a plurality of rotational components of the grass turning implement.

The implement may comprise a tillage implement. The one or more controllers may be configured for monitoring movement of the tillage implement (or ground engaging components thereof, for example) to identify a vibrational frequency or movement of the implement.

The implement may comprise a baling machine. This may be a towed baling machine operably coupled to a machine in the form of a tractor, for example. The one or more controllers may be configured to monitor operation of components thereof, e.g. during a bale forming and/or release process.

The implement may comprise a boom having one or more outlets for the dispensing of material therefrom. The boom may form part of a sprayer implement. The one or more controllers may be configured for monitoring operational parameters of one or more outlets (e.g. nozzles) of the sprayer boom, for example.

The one or more operable components of or otherwise associated with the machine may include a user interface. The user interface may comprise a display screen, which may be provided as part of a user terminal of the machine, e.g. in an operator cab of the machine. Additionally or alternatively, the user interface may be provided by a portable user device, e.g. one carried by a user/operator during operation of the machine. The portable user device may comprise a smartphone, tablet computer, laptop or the like.

The one or more controllers may be configured to control output of an indicator indicative of the determined operational parameter(s). Specifically, the one or more controllers may be configured to generate and output a control signal(s) to the user interface for causing output of the indicator via the user interface to an operator of the machine.

The indicator may comprise a warning indicative of an identified anomaly in the determined operational parameter(s), or other identified issue associated with the implement, for example. The warning may be an audible and/or a visual warning.

The indicator may comprise a representation of the implement, one or more components thereof; and/or a material flow associated therewith. For example, the one or more controllers may be configured to control output of a graphical representation of the implement, component(s); and/or material flow via the user interface. This may comprise senor data (e.g. an image feed from the one or more additional sensors) and/or a generated virtual representation of the implement; component(s) and/or material flow. The graphical representation may comprise a representation of the implement with an indicator provided and positioned with respect to the implement at the location of the identified anomaly/fault.

The one or more controllable operable components may comprise components of the machine or implement. For example, the one or more controllers may be configured to controlling a forward speed of the machine, which may include modifying the speed and/or bringing the machine to a stop in dependence on an identification of an anomalous operational parameter.

Additionally or alternatively, the one or more controllers may be configured to control one or more components of the implement. Where the implement comprises a header for a harvesting machine, this may include controlling an operational speed of rotational elements of the header, which may include a reel, augers or the like. This may include controlling an operational speed of conveyors or other components. This may include controlling a lift mechanism for the implement for controlling an operational position or height of the implement. Similarly, this may comprise bringing one or more operable component(s) of the implement to a stop in the event of a determination of an anomaly/fault. Where the implement comprises a baling machine, the one or more controllers may be configured to stopping a bale forming and/or release process in the event of a determination of an anomaly/fault. Where the implement comprises a grass turning implement, the one or more controllers may be configured for stopping operation of one or more rotatable components thereof in dependence on a determination of a fault with said component. The one or more controllers may be configured for controlling a hitch point of the machine, for example, to raise the implement to a non-operating position in dependence on a determination of a component fault. Where the implement comprises a tillage implement, the one or more controllers may be configured for controlling a hitch point of the machine, for example, to raise the implement to a non-operating position where the ground-engaging components thereof are out of contact with the ground.

The one or more controllers may collectively comprise an input (e.g. an electronic input) for receiving one or more input signals. The one or more input signals may comprise sensor data from the event based sensor. The one or more controllers may collectively comprise one or more processors (e.g. electronic processors) operable to execute computer readable instructions for controlling operational of the control system, for example, to identify one or more components and/or determine operational parameters therefrom. The one or more processors may be operable to generate one or more control signals for controlling operation of the one or more operable components. The one or more controllers may collectively comprise an output (e.g. an electronic output) for outputting the one or more control signals.

A further aspect of the invention provides an agricultural machine comprising the system of any aspect described herein. The agricultural machine may comprise a harvesting machine, such as a combine or forage harvester, for example. The agricultural machine may comprise a tractor having a hitch point or the like for coupling one or more implements thereto.

A further aspect of the invention provides a method of monitoring operation of an implement for an agricultural machine, the method comprising: receiving sensor data from the event based sensor; analysing the sensor data to identify one or more components of the implement and movement associated therewith; determining or more operational parameters of the component(s) in dependence on the sensor data; and controlling operation of one or more operable components associated with the agricultural machine in dependence on the determined operational parameter(s).

The method may comprise performing any one or more of the functionalities of the control system described hereinabove.

A further aspect of the invention provides computer software comprising computer readable instructions which, when executed by one or more electronic processors, causes performance of a method in accordance with any aspect described herein.

A yet further aspect of the invention provides a computer readable medium having the computer software of the preceding aspect of the invention stored thereon.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 is a simplified side view illustrating a combine harvester embodying aspects of the present disclosure;

FIG. 2 is a simplified schematic view of a header embodying aspects of the present disclosure;

FIG. 3 is a schematic illustrating an embodiment of a system of the present disclosure;

FIG. 4 graphically illustrates sensor data obtained in performance of embodiments of the disclosure described herein; and

FIG. 5 schematically illustrates a tractor embodying aspects of the present disclosure.

### DETAILED DESCRIPTION

With The figures illustrate embodiments of the present disclosure. Specifically, illustrated herein is illustrated a system 100 for monitoring operation of an implement, specifically a header 12 for an agricultural machine, specifically here a combine harvester 10. The system includes the use of an event based sensor 60; and a control system 101 which, as described herein, is configured to: receive sensor data from the event based sensor 60 indicative of an operating region of the implement and use this sensor data for controlling operation of one or more operable components associated with the harvester 10, which may include components of the header 12, or other components associated with the harvester 10, e.g. a user interface 62.

### Harvester

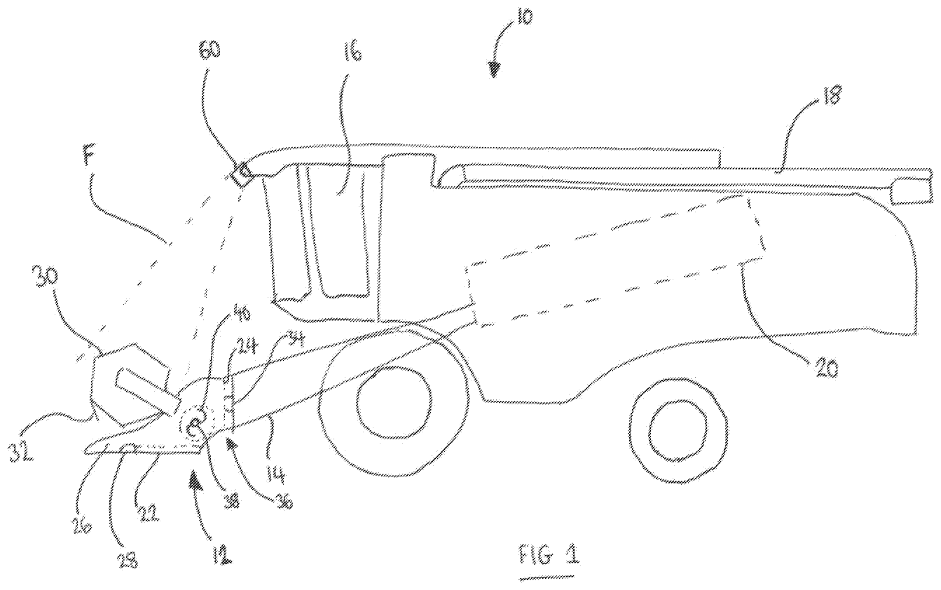

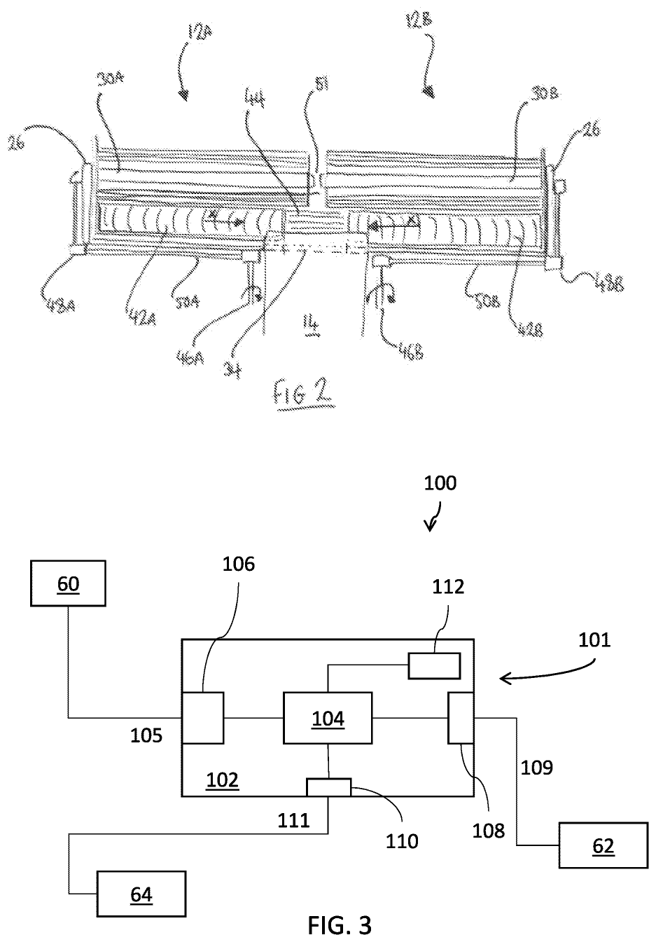

FIGS. 1 and 2 illustrate an agricultural machine in the form of a combine harvester 10 and implement in the form of a header 12 coupled to the harvester 10 illustrating aspects of the present invention.

The harvester 10 has the header 12 coupled in a known manner to a feederhouse 14 of the harvester 10. The harvester 10 also includes an operator cab 16, unloading auger 18 and a crop processing mechanism, indicated generally at 20, which is operable to separate grain and other crop material from the supporting crop matter. Various different configurations for the crop processing mechanism 20 are known, and will be apparent to the person skilled in the art so will not be described in detail herein. The invention is not limited in this sense.

The header 12 has a frame comprising a table (alternatively termed a bed or floor) 22, a rear wall 24 and two side walls 26. A standing crop such as cereals or maize is cut by a cutter bar 28 which is disposed on a leading edge of the table 22 as the harvester 10 advances in a forward direction across a crop field. A reel 30 is provided which guides the cut crop into the header 12. The reel 30 includes a plurality of guide bars 32, here six, which are mounted on (hexagonal) wheels which rotate around a transverse axis above the cutter bar 28. As particularly shown in FIG. 2, the illustrated header 12 comprises two crop gathering mechanisms or sub-assemblies (respectively identified by the suffixes A and B) 12A, 12B each having a respective reel 30A, 30B.

In FIG. 1, each sub-assembly 12A, 12B comprises an auger 36 which is suspended transversely across the width of the respective sub-assembly 12 in close proximity to the rear wall 24 and table 22. The auger 36 comprises a rotor core 38 supported for rotation by a support shaft (not shown). Screw-flighting 40 is secured to the rotor core 38. In operation, the auger 36A rotates and the flighting 40 engages the cut crop material so as to convey the crop material inwardly toward the centre of the header 12 e.g. in the direction of respective arrow X shown in FIG. 2.

FIG. 2 shows an alternative means for conveying the cut crop across the table 22 of the respective sub-assemblies 12A, 12B in the form of draper belts 42A, 42B which are driven conveyors extending across the respective portions of table 22 and which convey the cut crop inwardly in the direction of arrows X towards an opening 34.

In the illustrated embodiment in FIG. 2, the header 12 includes a further belt 44 in a central section between the sub-assemblies 12A, 12B. This further belt 44 operates transversely to the draper belts 42A, 42B (having received cut crop deposited by the draper belts) and carries the cut crop through the opening 34 and into the feederhouse 14 for onward handling by the crop processing mechanism 20.

In this embodiment, the crop gathering mechanisms (reels 30 and draper belt 42 or auger 36) of one header sub-assembly are operable independently of the (or each) other. As described in further detail herein, independent control of each sub-assembly 12A, 12B may be utilised in the present disclosure in dependence on operational parameters of these or other components of the header 12, as determined through analysis of sensor data from the event based sensor 60.

In order to provide independent drive to the sub-assemblies, different options are possible and the invention is not limited in this sense. In the example shown in FIG. 2, mechanical drive is provided by separate (and independently driven) driveshafts 46A, 46B extending from the harvester 10, and via one or more universal joints 48A, 48B and intermediate driveshafts 50A, 50B, the rotation of the driveshafts is transferred to drive rotation of the respective reels 30A, 30B. As an alternative to mechanical drive, one or more of the crop gathering components may be provided with electric drive through one or more electric motors mounted on the header and driving the components directly. This arrangement is preferred where there are e.g. four or more sub-assemblies as the control connections become simpler than having multiple mechanical drive shafts, and the (generally shorter) header sections and sub-assemblies will require less power to drive.

The preceding description is provided for background, and illustrates how the header 12 may operate to provide a material flow into and through the header 12 through interaction with the components thereof.

### Event Based Sensor

As discussed herein, the present invention utilises an event based sensor 60 mounted on a foremost point of the operator's cab 16 and having a field of view which encompasses the header 12, and in particular an operating region of the header 12.

Event based sensor 60 has multiple individual sensing elements (pixels) which are individually triggerable in dependence on one or more variations in the signal output associated with those elements. The one or more variations result from a change in the light incident on said sensing elements, resulting in a change in amplitude in the output signal of those sensing elements. By setting relevant thresholds for said variations, “events” can be triggered in dependence on a given change in incident light on said sensing elements. The variations can be used as an indication of movement in the observed environment, for example, by monitoring successive triggers of adjacent sensing elements, and inferring movement in the observed scene based thereon. In further arrangements the overall sensor output for a given time period may be used—e.g. forming of a histogram or heat map of triggers—to obtain a measure of an overview of a given process—e.g. shape/size of flowpath material distribution, etc.

Operation of the event based sensor 60 may be controlled based on the given scenario. For instance a filter may be applied to the sensing elements to control at what magnitude of change/variation said sensing elements are triggered. This may be utilised to remove background events from the data. For instance, when using the sensor 60 on the harvester 10 during a harvesting operation, motion of the ground with respect to the harvester 10 may otherwise trigger the sensing elements. Accordingly, a filter can be applied based on the ground speed of the harvester 10 to reduce or eliminate false triggers thereof. Where the sensor 60 is used to monitor operation of components of the harvester 10, such as the header 12, or a material flow associated therewith, the operational speed of the implement/header 12 may be used to determine the filter to be applied to the sensor data to remove cyclical or repetitive motion from the scene—e.g. in order to identify anomalies or changes in that motion indicative of an operational issue.

In yet further use cases, a clustering process may be applied to the sensor data. This clustering may be a timewise and/or location based clustering to identify triggers at multiple sensing elements which correlate to the same physical observation. For instance, data may be clustered timewise to identify (and optionally track movement of) individual material components (e.g. pieces of straw or other crop material) in the sensor data. Clustering may be applied in dependence on a determined flow velocity of material (e.g. as determined through application of an optical flow measurement of the sensor data) which may be used to indicate regions within the field of view of the sensor where material may be travelling at different speeds to other regions or compared with an expected flow parameter. Regions within the sensing area where no triggers are seen (in areas where they would be expected—e.g. corresponding to a region of the header 12) may be indicative of a plugging of material or other fault preventing material flow in that region.

In the illustrated examples, and as described herein, the sensor data from event based sensor 60 is utilised to determine one or more operational parameter(s) associated with operable components of the header 12. As discussed herein, the one or more operational parameters include an operational speed for one or more components of the header; and/or a measure of a structural vibration of one or more components of the implement, which may include a measure of a frequency and/or amplitude of said vibration, for example. The control system 101 (discussed hereinbelow) is configured in embodiments to determine a measure of a variation in an operational characteristic observed from the sensor data. For instance, the control system 101 may be configured to compare the observed vibration measure with a threshold and infer an issue with the observed component(s) in dependence thereon.

### System

FIG. 3 illustrates an embodiment of a system 100 of the present disclosure. As discussed herein, the system 100 comprises a control system 101 operably connected to event based sensor 60. The control system 101 is configured for controlling one or more operational components 62, 64 associated with the harvester 10. In the illustrated embodiment, the controllable operational components include a local control unit 64 for controlling operation of the header 12 and one or more operable components thereof—e.g. reels 30, in dependence on flow parameters, determined in the manner discussed herein, and a user interface 62 associated with the combine harvester 10, here provided as a display terminal 62 in the operator cab 16 of the harvester 10 to provide a representation of the determined flow parameter(s).

Control system 101 comprises a controller 102 having an electronic processor 104, an electronic input 106 and electronic outputs 108, 110. The processor 104 is operable to access a memory 112 of the controller 102 and execute instructions stored therein to perform the steps and functionality of the present disclosure discussed herein, e.g. by controlling the user interface 62 to provide a representation of one or more operational parameters determined from sensor data from the event based sensor 60, and/or controlling operation of operable components of the header 12.

The processor 104 is operable to receive sensor data from event based sensor 60 via input 106 which, in the illustrated embodiment, takes the form of input signals 105. The sensor data is indicative of an operating region of the header 12. As discussed herein, the event based sensor 60 is mounted or otherwise coupled to the harvester 50 and obtain said sensor data as the harvester 50 moves through the environment.

The processor 104 is configured to analyse the sensor data and identify therefrom one or more operational parameters of the header 12 or components thereof, e.g. the reels 30, augers 38, draper belts 42, etc. This may include a measure of the operational speed of said components, or a measure of a structural vibration associated with said components, as discussed herein.

Controller 102 includes an electronic output 110 configured to output control signals 111 generated by the processor 104 for controlling operation of the header 12. Specifically, processor 104 is operable to generate, and the controller 102 operable to then output via output 108, control signals 109 to a local control unit 64 of the header 12 for controlling operable components thereof. As discussed herein, this may include controlling an operational speed of the components, e.g. of one or more reels 30, augers 38, draper belts 42, etc. in dependence on the operational parameters. This may include increasing or reducing the speed of the component(s). This may include bringing the component(s) to a stop to prevent damage—e.g. where the determined operational parameter(s) are indicative of a blockage in a particular region of the header 12, or component fault. This may be inferred where one region or a given component is determined to be moving at a different speed to other areas of the header 12, or compared with an expected movement profile for a given operation.

Output 108 is operably coupled to the user interface 62 in the form of a display terminal in the operator cab 16. As will be appreciated and is discussed herein, in alternative arrangement the user interface 62 may form part of a portable device, such as a phone or tablet computer. Here, the control system 101 is operable to control operation of the user interface 62, e.g. through output of control signals 109 in order to display data to an operator of the harvester 10 relating to the operation of the control system 101. Specifically, the control system 101 is operable to control the user interface 62 to display to the operator a representation of sensor data from the event based sensor 60, a material flow associated with the header 12 and/or a representation of the determined one or more operational parameters—such as a warning or other indicator of one or more component faults determined in dependence on the operational parameter(s).

### Sensor Data

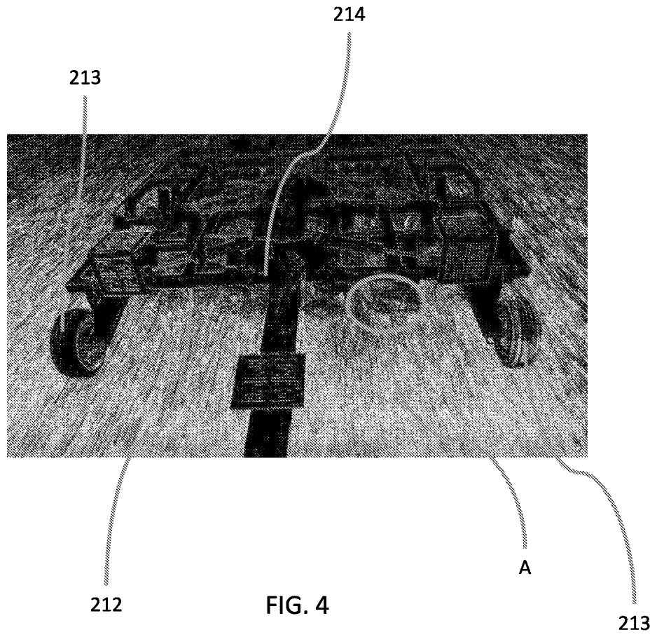

FIG. 4 illustrates sensor data obtained by system 100 imaging an implement in the form of a harrow 212.

As will be appreciated, the harrow 212 comprises a series of ground engaging members which are operable, in use, to disturb and break up the soil surface. In the sensor data obtained by the event based sensor, this is shown through sensing element triggers in the sensor data, e.g. in region A in FIG. 4. In an extension of the system discussed herein, this movement or flow of soil material with respect to the harrow 212 may be monitored to monitor implement operation. For instance, material moving through the image is shown having a tail of previous triggered sensing elements. By selecting a suitable “decay time” for displaying triggers, the length of the “tail” can be used to determine speed and its directionality can indicate a material flow direction.

Here, system 100 is configured to monitor movement of the implement itself. For instance, here, the system 100 may be configured to monitor the rotational speed of the wheels 213 of harrow 212 as the implement is pulled across a field surface. This can be useful for identifying any dragging or slipping of the wheels, for example, or any further issue causing the wheels to rotate (or not) at different speeds when compared with an expected speed, e.g. as determined knowing the ground speed of the tractor pulling the harrow 212. As discussed herein, measurement of the rotational speed may include determining a time for a given event to traverse a complete cycle in the sensor data. In an extension, vibration of further components of the harrow may be inferred, e.g. by looking at a trigger frequency of sensing elements corresponding to the frame 214 of the harrow, for example. Excessive vibration of the frame may be indicative of a component fault or heavy load on the harrow 212.

### Alternative Arrangements

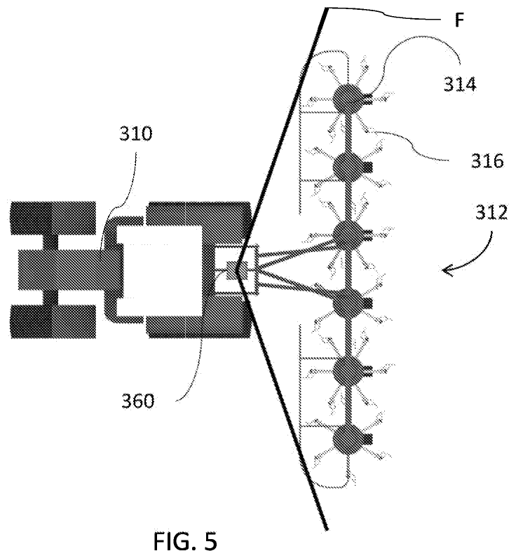

FIG. 5 illustrates an alternative arrangement where system 100 is incorporated onto a tractor 310 having an implement, here in the form of a grass turning implement 312, 16 operably coupled thereto. Event based sensor 360 is mounted on the rear of the tractor cab and has a field of view F which encompasses the implement 312 and the surrounding. As discussed herein, system 100 may be configured in a manner to determine one or more operational characteristics of the implement 312, including a movement and vibration thereof. Specifically here, the system 100 is configured for monitoring an operational characteristic of rotational components of the implement 312. In the illustrated embodiment, the implement 312 comprises a plurality of rotational members 314 having grass engaging tines 316 operably coupled thereto. As will be appreciated, in use, the rotational members 314 are configured to rotate about a central axis in turn causing rotation of the tines thereabout that axis. In engagement with grass or other cut crop material, the tines 316 provide a propulsive force to the material to disperse that material with respect to the implement 312. This is a conventional operation of such an implement, as will be appreciated.

The system 100 here is configured to monitor this rotational motion and specifically the rotational frequency of the components to identify one or more faults therewith in the manner discussed herein. In an extension of this, the system 100 may receive operational data from a controller network of the tractor 310 indicative of the operation of a power take off shaft (PTO) thereof providing motive force to the rotational components of the implement 312. The controller 102 can utilise this information from the controller network to determine an expected operational frequency for the rotational components 314 of the implement 312 and compare this with the sensor data from event based sensor 360 to identify one or more anomalies therewith.

### General

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine readable storage storing such a program. Still further, embodiments of the present invention may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

What is claimed is:

1. A system for monitoring operation of an implement for an agricultural machine, the system comprising:
an event based sensor; and
one or more controllers, configured to:
receive sensor data from the event based sensor;
analyse the sensor data to identify one or more components of the implement and movement associated therewith;
determine or more operational parameters of the component(s) in dependence on the sensor data; and
generate and output one or more control signals for controlling operation of one or more operable components associated with the agricultural machine in dependence on the determined operational parameter(s).

2. A system as claimed in claim 1, wherein the one or more operational parameters include an operational speed for one or more components of the implement.

3. A system as claimed in claim 1, wherein the one or more operational parameters include a measure of a variation in an operational characteristic observed from the sensor data.

4. A system as claimed in claim 1, wherein the one or more operational parameters include a rotational frequency of one or more rotational components of the implement.

5. A system of claim 1, wherein the one or more operational parameters include a measure of a structural vibration of one or more components of the implement.

6. A system of claim 5, wherein the measure of structural vibration includes a measure of a frequency and/or amplitude of said vibration.

7. A system as claimed in claim 5, wherein the one or more controllers are configured to compare the observed vibration measure with a threshold and infer an issue with the observed component(s) in dependence thereon.

8. A system of claim 1, wherein the one or more controllers are configured to control application of a filter to the output signal from sensing elements of the event based sensor to remove triggers thereof due to background motion.

9. A system as claimed in claim 8, wherein the filter comprises a threshold for a signal parameter associated with the sensing elements, the threshold comprising an amplitude or rate of change of amplitude of the associated signal.

10. A system of claim 8, wherein the filter is dependent on:
a ground speed of the agricultural machine; and/or an operational speed of the implement.

11. A system of claim 8, wherein the filter comprises a mask applied to a sensing region of the sensor to exclude regions of the sensing region which do not correspond to the implement.

12. A system of claim 1, comprising one or more additional sensors; and wherein the one or more controllers are configured to use data from the one or more additional sensors for positioning of the implement within the sensor data from the event based sensor.

13. A system of claim 1, wherein the implement comprises: a header for a harvesting machine; a grass turning implement; a tillage implement; or a baling machine.

14. A system of claim 1, wherein the one or more operable components of or otherwise associated with the machine comprises a user interface.

15. A system of claim 14, wherein the one or more controllers are configured to generate and output a control signal(s) to the user interface for causing output of an indicator indicative of the determined operational parameter(s) via the user interface to an operator of the machine.

16. A system of claim 15, wherein the indicator comprises an audible or visual warning indicative of an identified anomaly in the determined operational parameter(s), or other identified issue associated with the implement.

17. A system of claim 15, wherein the indicator comprises a representation of the implement, one or more components thereof, and/or a material flow associated therewith.

18. A system of claim 17, wherein the one or more controllers are configured to control output of a graphical representation of the implement, component(s); and/or material flow via the user interface; and wherein the graphical representation comprises a representation of the implement with an indicator provided and positioned with respect to the implement at the location of the identified anomaly/fault.

19. A system of claim 1, wherein the one or more controllable operable components comprise components of the machine or implement.

20. A system of claim 19, wherein the one or more controllers are configured to control:
a forward speed of the machine; and/or
an operational speed of one or more components of the implement.

21. An agricultural machine comprising the system of claim 1.

22. A method of monitoring operation of an implement for an agricultural machine, the method comprising:
receiving sensor data from the event based sensor;
analysing the sensor data to identify one or more components of the implement and movement associated therewith;
determining or more operational parameters of the component(s) in dependence on the sensor data; and
controlling operation of one or more operable components associated with the agricultural machine in dependence on the determined operational parameter(s).
